(19) United States
(12) Patent Application Publication
(10) Pub. No.: US 2026/0358673 A1
(43) Pub. Date: Nov. 12, 2026

(54) SPATIAL MODEL VOXEL GENERATION

(71) Applicant: Microsoft Technology Licensing, LLC, Redmond, WA (US)

(72) Inventors: Joona Juhana KOPONEN, Vantaa (FI); Simo Kaarlo TAMMELA, Espoo (FI); Esa Tapani RAIKKONEN, Espoo (FI)

(21) Appl. No.: 19/201,509

(22) Filed: May 7, 2025

(51) Int. Cl. G02F 1/295; G02F 1/33

(52) U.S. Cl. CPC G02F 1/295; G02F 1/33

(57) ABSTRACT

A light delivery system for use in generating voxels is described. The light delivery system comprises a modulator and one or more waveguides, wherein the modulator is controllable to cause a deflection of an input light beam from a first optical path to a second optical path through the one or more waveguides, wherein the first and second optical paths have different propagation properties, resulting in a different spatial distribution of an output light beam output from the light delivery system.

### BACKGROUND

Data written to glass plates provides a sustainable, compact, long term storage solution. Writing the data involves using a laser system to modify the glass (e.g. fused silica) by inducing for example a change in the refractive index. Each individual region of modified refractive index is referred to as a voxel and can store one or more bits of data. The data can then subsequently be read using a computer-controlled quick-moving microscope that can be moved rapidly to the data a user wants to retrieve. Compared to alternative storage solutions which use magnetic technology, the lifetime of the data stored in the glass plates is enormous (e.g. thousands of years compared to perhaps 5-10 years).

The embodiments described below are not limited to implementations which solve any or all of the disadvantages of known methods of writing data to glass plates.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A light delivery system for use in generating voxels is described. The light delivery system comprises a modulator and one or more waveguides, wherein the modulator is controllable to cause a deflection of an input light beam from a first optical path to a second optical path through the one or more waveguides, wherein the first and second optical paths have different propagation properties, resulting in a different spatial distribution of an output light beam output from the light delivery system.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows examples of the spatial intensity profiles of a beam of light for different propagation modes;

FIG. 2 is a high level diagram of a first example system for generating voxels;

FIG. 3 shows a first example light delivery system that may be used to generate voxels with different spatial intensity profiles;

FIG. 4 shows a second example light delivery system that may be used to generate voxels with different spatial intensity profiles;

FIG. 5 shows a third example light delivery system that may be used to generate voxels with different spatial intensity profiles;

FIG. 6 shows a fourth example light delivery system that may be used to generate voxels with different spatial intensity profiles;

FIG. 7 shows a fifth example light delivery system that may be used to generate voxels with different spatial intensity profiles;

FIG. 8 shows a method of operating a light delivery system as described herein as part of a broader method of generating voxels using the apparatus described herein;

FIG. 9 is a high level diagram of a second example system for generating voxels; and

FIG. 10 shows a method of operating a light delivery system shown in FIG. 9 as part of a broader method of generating voxels using the apparatus described herein.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

As described above, each individual region of modified refractive index that is used to store data is referred to as a voxel. Current voxels are written, and different bit values stored, by controlling the pulse energy of the femtosecond (fs) lasers that are used as the light source, (i.e. controlling the amplitude of the pulses) when inducing the index change in the glass plate. These types of voxels are often referred to as phase voxels. This means that each of the voxels are the same shape, but the magnitude of the refractive index change is dependent upon the incident pulse energy that is used to generate the voxel. However, given the small dynamic range of the induced refractive index change, the process window for generating each voxel is very narrow and as a result it is difficult to store multiple bits within a single voxel by modulating the pulse energy.

Described herein is an improved method of generating voxels which uses changes in the spatial intensity profile to store bit values, i.e. the shape of the voxel is changed. This is referred to herein as ‘spatial mode voxel generation’ and this technique may be used independently of, or in combination with modulation of the pulse energy, to increase the number of bits of data that can be stored in a voxel. For example, by using the methods described herein and writing one of two different shaped voxels, the number of bits of data that can be stored in a voxel increases by one. Additional shapes increase the amount of bits accordingly.

To change the shape of a voxel, the shape (i.e. the spatial intensity profile) of the pulse of incident light that induces the refractive index change in the glass substrate is changed. This change is implemented quickly so that the high writing speeds can be maintained and in the examples described herein, the spatial intensity profile is modified by deflecting the incident laser beam and using different guiding properties (which may also be referred to as propagation properties) along different optical paths through one or more waveguides, where these waveguides may be fibers (e.g. solid core fibers, multi-core fibers, or hollow core fibers) or planar waveguides (i.e. waveguides formed on the surface of a substrate).

The beam deflection may be implemented using a high speed modulator, such as an acousto-optic modulator (AOM) or an electro-optic modulator (EOM). An AOM deflects an input light beam so that, dependent upon the applied modulation signal (which may be referred to as a control signal), a controlled fraction of the output beam propagates to the diffracted directions, and the rest propagates through the modulator without deflection. Where an EOM is used, the EOM modulates the polarization of the input light beam, dependent upon the applied modulation signal (which may be referred to as a control signal), and so the EOM is used in combination with a polarization splitter (e.g. in the form of a birefringent crystal) so that the two polarizations propagate out from different spatial positions or in different directions (i.e. at different output angles). AOMs support higher incident powers of light than EOMs; however, EOMs may operate faster than AOMs. Consequently implementations may use either an AOM or an EOM as shown in the examples described below. Where EOMs are used, amplification may also be implemented, to boost the light power after passing through the EOM and polarization splitter.

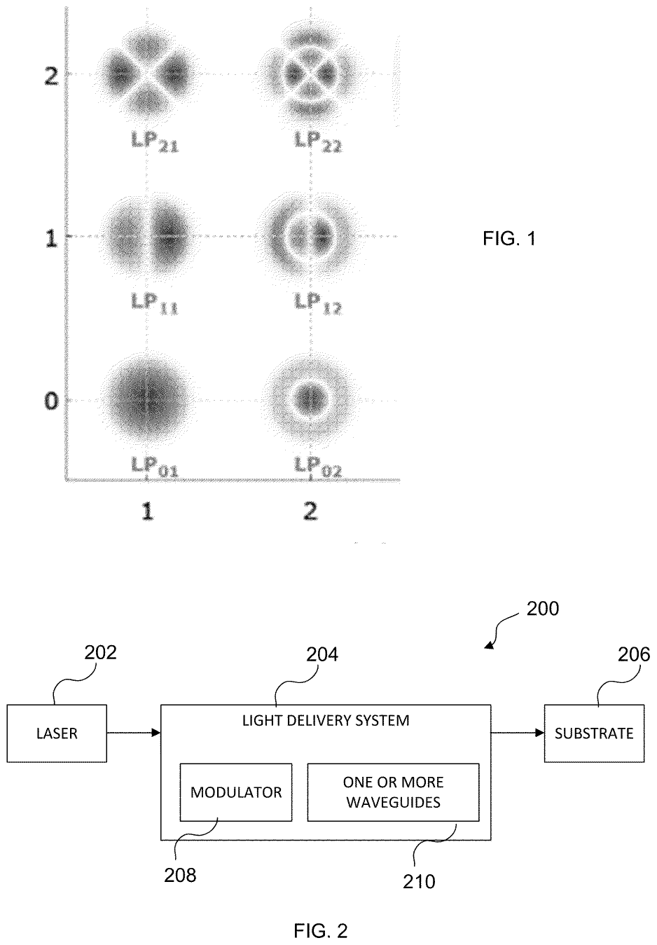

The beam deflection that is caused by the modulator may enable the output light to be selectively coupled into one of a plurality of different waveguides, where these different waveguides may be different cores within a multi-core fiber, different waveguides within a planar waveguide or different fibers. These different waveguides have different transmission properties such that dependent upon which waveguide the light is coupled into, the light output from the waveguide has a different spatial intensity profile. The different spatial intensity profiles may correspond to different modes which are able to propagate within the waveguides (e.g. the fundamental mode and one or more higher order modes). There are many different ways in which this propagation of different modes can be achieved, including through the use of few-moded fiber in combination with a long period grating (LPG) or an offset splice. Alternatively, the beam deflection that is caused by the modulator may enable output light to be selectively coupled into one of a plurality of different propagation modes within a single length of few-moded fiber. A few-moded fiber is a fiber that has a core diameter and numerical aperture (NA) that together exceed the single mode limit of the waveguide (i.e. the fiber) therefore enabling propagation of a small number of higher order modes (HOM). FIG. 1 shows examples of the spatial intensity profiles of a beam of light for different propagation modes. This includes the spatial intensity profile of the fundamental mode, LP₀₁, and the spatial intensity profile for five higher order modes, LP₁₁, LP₀₂, LP₁₂, LP₂₁, LP₂₂. As shown in FIG. 1, whilst the spatial intensity profile for the fundamental mode is circular, the spatial intensity profiles for higher order modes are more complex and generally non-circular. In examples where a higher order mode is selectively excited in order to change the spatial intensity profile, and hence the shape of the voxel, the first higher order mode, LP₁₁, may be used in preference to the other higher order modes because it is the strongest and has the simplest spatial intensity profile which is different to the fundamental mode, LP₀₁. Additionally the other higher order modes may be lossy or have high bend loss (i.e. realistically can only propagate for a limited distance within a fiber) which may mean that the fiber length prior to the coupling optics to the substrate has to be kept very short.

Instead of using different propagation modes within waveguides which have the same shaped core (e.g. cores which are circular in cross-section), the plurality of different waveguides may have different shaped cores (e.g. circular cores and elliptical cores). The different shaped cores result in different spatial intensity profiles of the light output from each of the different waveguides.

FIG. 2 is a high level diagram of a system 200 for generating voxels. The system 200 comprises a laser 202 (e.g. a femtosecond laser), a light delivery system 204 and a substrate 206. The light delivery system 204 receives the light output by the laser 202 and generates light with the desired spatial intensity profile which is then incident upon the substrate 206 to induce the index change in the material and form the voxel. The light delivery system 204 therefore comprises the modulator 208 and the one or more waveguides 210 as described above. The high level diagram is a simplification of the full system, and parts not directly involved with the invention like femtosecond laser stretchers, compressors, wavelength converters, and the focusing optics to substrate are left out for clarity.

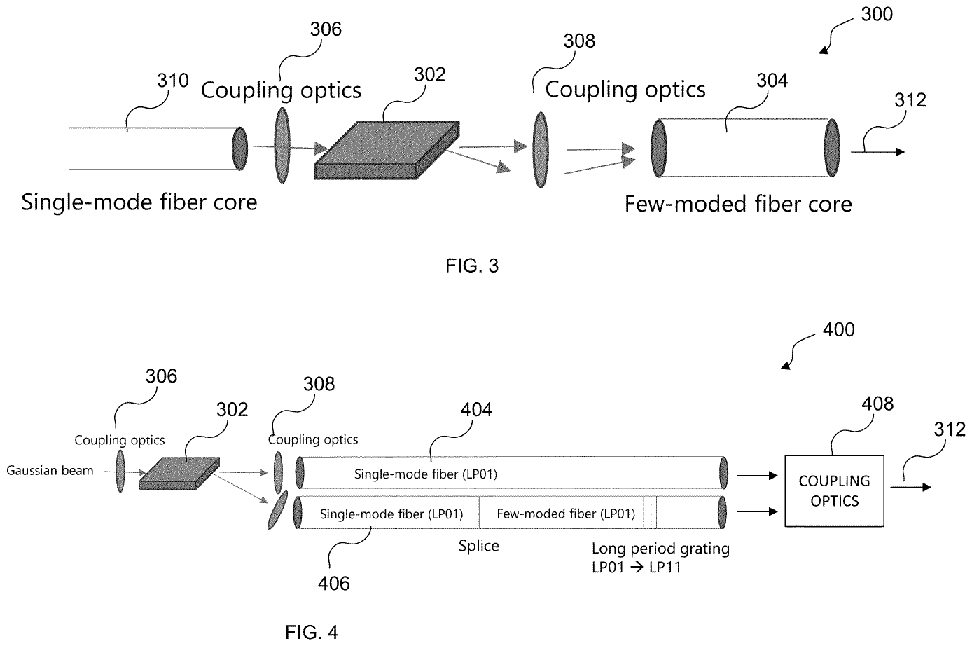

Various examples of light delivery systems 204 are described below with reference to FIGS. 3-7. Whilst these examples are described with reference to fiber-based waveguides, in a variation on the examples described, the waveguides may be planar waveguides rather than fibers. Furthermore, whilst the examples shown in FIGS. 3-7 are described with reference to solid core fibers, in other examples, hollow core fibers may be used.

When writing voxels there may be many systems 200 operating in parallel so that multiple voxels can be generated at the same time. In such a parallel arrangement, there may be a separate laser source 202 for each system 200 or there may be a single laser 202 and an optical splitter that splits the light output by the laser 202 and delivers light to a plurality of light delivery systems 204.

FIG. 3 shows a first example light delivery system 300 that may be used to generate voxels with different spatial intensity profiles. The light delivery system 300 comprises an AOM 302 and a few-moded fiber 304. An input beam of light (from the laser 202) is coupled into the AOM 302 via first coupling optics 306. This beam may have a Gaussian profile and in the example shown in FIG. 3, is output from a single mode fiber 310, although in other examples, this input fiber 310 may be omitted and the input beam may propagate in free space from the laser to the first coupling optics 306. As described above, the AOM 302 selectively deflects the input light, based on a control signal (not shown in FIG. 3). The output beam from the AOM 302 is coupled via second coupling optics 308 into the few-moded fiber 304. Dependent upon the incident angle and position of the beam onto the few-moded fiber 304, a different mode of the few-modes is excited and propagates within the fiber. For example, if there is no deflection the fundamental mode, LP₀₁, may be excited, whereas if the beam is deflected by the AOM 302, a higher order mode (e.g. LP₁₁) may be excited. The particular mode or modes that are excited is dependent upon the overlap integral of the incident beam and the different modes that can propagate within the few-moded fiber. Consequently, by selectively deflecting the input beam using the AOM 302, the spatial intensity profile of the output beam 312, which is then incident on the substrate 206 to generate a voxel, can be changed.

In a variation of that shown in FIG. 3, the few-moded fiber 304 may be replaced with a multi-core fiber where different cores in the multi-core fiber have different propagation properties. This may, for example, be because one core supports the fundamental mode and another core supports a higher order mode, or because one core is circular in cross-section, whilst the another core is elliptical in cross-section. Light that has propagated through an elliptical core before being incident on a substrate will induce a different shaped voxel compared to light that has propagated through a circular core.

FIG. 4 shows a second example light delivery system 400 that may be used to generate voxels with different spatial intensity profiles. Like the example shown in FIG. 3, the light delivery system 400 shown in FIG. 4 comprises an AOM 302 and first and second coupling optics 306, 308. FIG. 4 does not show an input fiber 310 and the light delivery system 400 may comprise an input fiber 310 or instead the input beam may propagate in free space from the laser to the first coupling optics 306. As described above, the AOM 302 selectively deflects the input light, based on a control signal (not shown in FIG. 4) and dependent upon the deflection couples the light into different waveguides 404, 406. The first waveguide 404 is a single mode fiber and so if the input beam is coupled into this first waveguide 404 it propagates in the fundamental mode, LP₀₁. The second waveguide 406 is formed from a length of single mode fiber (in which light propagates in the fundamental mode, LP₀₁) spliced to a length of few-moded fiber. A long period grating (LPG) within the few-moded fiber causes light to be coupled from the fundamental mode, LP₀₁, to a higher order mode (e.g. LP₁₁). Third coupling optics 408 combine light output by each of the waveguides 404, 406 to the same optical path to form the output beam 312. This third coupling optics 408 may, for example, be implemented in free-space, using a diffractive element such as a surface relief grating or using a fiber coupler, etc. By selectively deflecting the input beam using the AOM 302, the spatial intensity profile of the output beam 312, which is then incident on the substrate 206 to generate a voxel, can be changed.

In a variation of that shown in FIG. 4, the two waveguides 404, 406 may be replaced by two multi-core fibers spliced together with the first multi-core fiber (proximate to coupling optics 308) comprising two single mode cores and the second multi-core fiber (proximate to coupling optics 408) comprising a single mode core and a few-moded core. The two multi-core fibers are spliced together with the cores aligned such that the first waveguide comprises a first single mode core in the first multi-core fiber and a first single mode core in the second multi-core fiber, whereas the second waveguide comprises a second single mode core in the first multi-core fiber and a few-moded core in the second multi-core fiber. A LPG within the few-moded core of the second multi-core fiber causes light to be coupled from the fundamental mode, LP₀₁, to a higher order mode (e.g. LP₁₁) in the same way as described above with reference to FIG. 4.

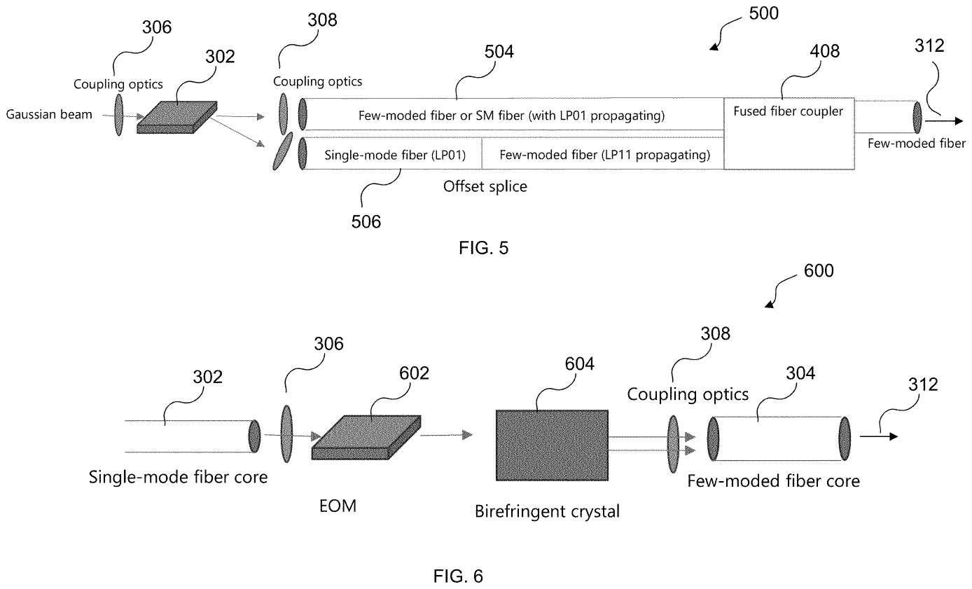

FIG. 5 shows a third example light delivery system 500 that may be used to generate voxels with different spatial intensity profiles. Like the examples shown in FIGS. 3 and 4, the light delivery system 500 shown in FIG. 5 comprises an AOM 302 and first and second coupling optics 306, 308. FIG. 5 does not show an input fiber 310 and the light delivery system 500 may comprise an input fiber 310 or instead the input beam may propagate in free space from the laser to the first coupling optics 306. As described above, the AOM 302 selectively deflects the input light, based on a control signal (not shown in FIG. 5) and dependent upon the deflection couples the light into different waveguides 404, 506. The light propagates in the first waveguide 504 in the fundamental mode, LP₀₁, and this first waveguide 504 is either a single mode fiber or a few-moded fiber. The second waveguide 506 is formed from a length of single mode fiber (in which light propagates in the fundamental mode, LP₀₁) spliced to a length of few-moded fiber. Instead of using a LPG to cause light to be coupled from the fundamental mode, LP₀₁, to a higher order mode (e.g. LP₁₁), an offset splice is used between the cores of the single mode fiber and the few-moded fiber. This lateral offset of cores causes excitation of a higher order mode (e.g. in a similar manner to the deflection in the first example shown in FIG. 3). In an example, the magnitude of offset between the cores in the second waveguide 506 may be approximately 10% of the core diameter. In another example, the offset may be less than 5 μm for core diameters of 10-20 μm. Third coupling optics 408 combine light output by each of the waveguides 404, 506 to form the output beam 312. Where the first waveguide 504 is a few-moded fiber, the third coupling optics 408 may comprise a fused fiber coupler. By selectively deflecting the input beam using the AOM 302, the spatial intensity profile of the output beam 312, which is then incident on the substrate 206 to generate a voxel, can be changed.

FIG. 6 shows a fourth example light delivery system 600 that may be used to generate voxels with different spatial intensity profiles. The light delivery system 600 comprises an EOM 602, a birefringent crystal 604 and a few-moded fiber 304. An input beam of light (from the laser 202) is coupled into the EOM 602 via first coupling optics 306. This beam may have a Gaussian profile and in the example shown in FIG. 6, is output from a single mode fiber 310, although in other examples, this input fiber 310 may be omitted and the input beam may propagate in free space from the laser to the first coupling optics 306. As described above, the EOM 602 selectively modulates the polarization of the input light, based on a control signal (not shown in FIG. 6). The output beam from the EOM 602 is input to the birefringent crystal 604 and the two polarizations propagate out from different spatial positions. The light output from the birefringent crystal 604 is coupled via second coupling optics 308 into the few-moded fiber 304. Dependent upon the incident angle and position of the beam onto the few-moded fiber 304, a different mode of the few-modes is excited and propagates within the fiber. For example, for the first polarization the fundamental mode, LP₀₁, may be excited, whereas for the second polarization, a higher order mode (e.g. LP₁₁) may be excited. Consequently, by selectively changing the polarization of the input beam using the EOM 602, the spatial intensity profile of the output beam 312, which is then incident on the substrate 206 to generate a voxel, can be changed.

In a variation of that shown in FIG. 6 (and in a similar manner to FIG. 3 as described above), the few-moded fiber 304 may be replaced with a multi-core fiber where different cores in the multi-core fiber have different propagation properties. This may, for example, be because one core supports the fundamental mode and another core supports a higher order mode, or because one core is circular in cross-section, whilst the another core is elliptical in cross-section.

It can be seen that the fourth example light delivery system 600 shown in FIG. 6 corresponds to the first example light delivery system 300 shown in FIG. 3, with the difference being that the AOM 302 is replaced by an EOM 602 and a birefringent crystal 604. In further examples, the light delivery systems shown in FIGS. 4, 5 and 7 (described below) may be similarly modified by replacing the AOM 302 by an EOM 602 and a birefringent crystal 604. It will also be appreciated that the birefringent crystal 604 is one example of a polarization splitter and in other examples, a different form of polarization splitter may instead be used.

Where an EOM 602 is used, this may, for example, be implemented in Lithium Niobate (LiNbO₃). The birefringent crystal 604 may be implemented in the same material as the EOM 602 and so whilst FIG. 6 shows the EOM 602 and birefringent crystal 604 as two separate elements, they may instead be combined into a single element (e.g. in a single chip).

As described above, an EOM cannot support as high powers of input beam as an AOM. Consequently where an EOM is used, an optical amplifier may be included within the light delivery system (e.g. after the polarization splitter and before the light is incident on the substrate). For example, a few-moded optical fiber amplifier may be included (e.g. spliced to the output of the few-moded fiber 304.

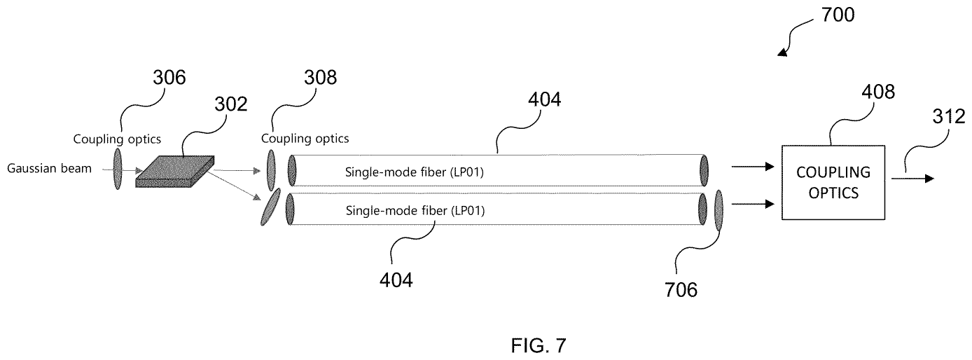

FIG. 7 shows a fifth example light delivery system 700 that may be used to generate voxels with different spatial intensity profiles. The system 700 shown in FIG. 7 is a variation on that shown in FIG. 3; however, instead of having two different fibers 404, 406, the light is selectively coupled into one of two identical fibers 404. The difference in the spatial intensity profile is instead caused by a non-circular lens 706, or other refractive or reflective optical element designed to change the intensity profile, positioned at the output of one of the two fibers. Consequently, by selectively deflecting the input beam using the AOM 302, the spatial intensity profile of the output beam 312, which is then incident on the substrate 206 to generate a voxel, can be changed.

Use of a single waveguide after the modulator, as shown in FIGS. 3 and 6 has the advantage that there is no need for coupling optics 408 and this can result in a more compact, less complex, light delivery system. However, as the extinction ratio of the modulator (whether an AOM or EOM) is unlikely to be 100%, whilst the majority of light will be coupled into the desired propagation mode (and hence generate the desired spatial intensity pattern), there will always be a small proportion of light that is coupled into another propagation mode (and hence generate a weak, but undesired spatial intensity pattern). This may result in some blurring of the resultant spatial intensity pattern compared to the optimal spatial intensity pattern; however, as the resulting spatial intensity patterns will still be different for the different modes, the resulting voxels will still have different shapes and be easily distinguishable. Furthermore the spatial intensity patterns that are generated, even if blurred, will be reproducible (e.g. such that all voxels representing the same bit value will have the same spatial intensity pattern and so the data encoded in the voxel can be subsequently read out accurately). By using a plurality of waveguides after the modulator, as shown in FIGS. 4, 5 and 7, the overall dynamic range of the induced spatial intensity can be increased by the design of the waveguides in comparison to spatial modes in a few-moded fiber, leading to increased signal to noise ratio, effectively reducing blurring.

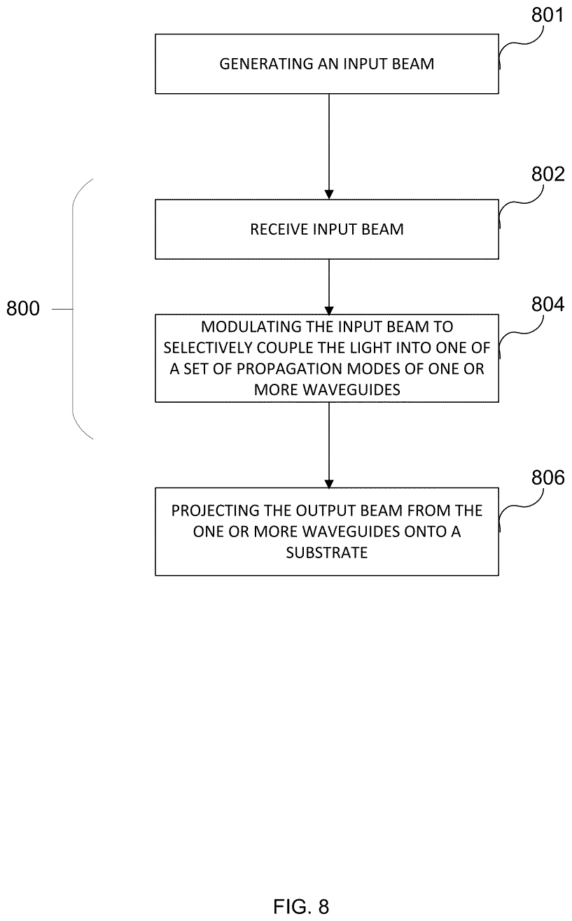

FIG. 8 shows a method 800 of operating a light delivery system as described herein as part of a broader method of generating voxels using the apparatus described herein (e.g. using the system of FIG. 2 and/or the light delivery system of any of FIGS. 3-7). The method 800 of operating the light delivery system comprises receiving an input beam (block 802) and modulating the input beam to selectively couple the light into one of a set of propagation modes of one or more waveguides (block 804). As described above this may involve (i) selectively coupling the input beam into one of a plurality of different propagation modes within the same waveguide (e.g. as in the examples in FIGS. 3 and 6) or (ii) selectively coupling the input beam into one of a plurality different waveguides having different propagation modes (e.g. as in the examples in FIGS. 4 and 5) before recombining the optical paths into a single output beam or (iii) selectively coupling the input beam into one of a plurality identical waveguides and then using a lens or other optical element to shape the beam output from one of the waveguides (e.g. as in the example in FIG. 7) before recombining the optical paths into a single output beam. This method 800 forms part of the method of generating voxels which additionally comprises generating the input beam (block 801), e.g. using a femtosecond laser, and projecting the output beam from light delivery system onto a substrate (block 806).

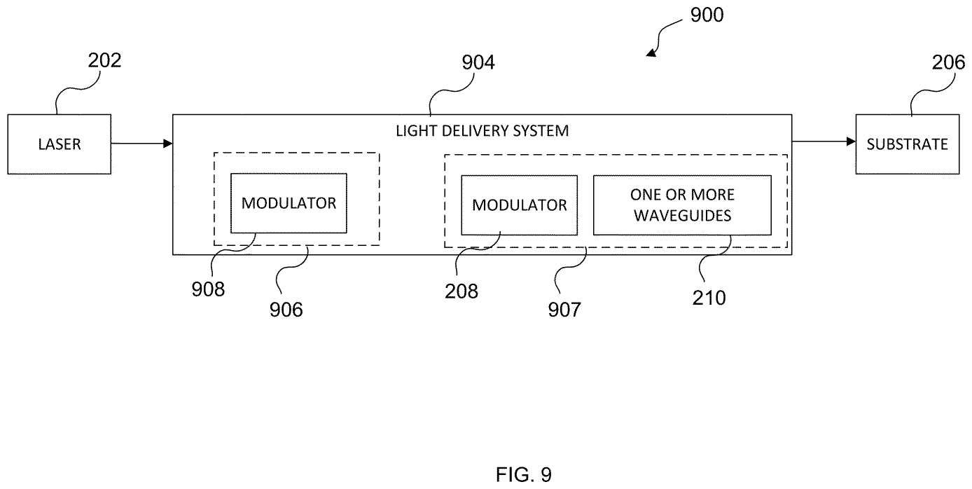

As described above, the methods of generating voxels using changes in the spatial intensity profile (spatial mode voxel generation) may be used in combination with intensity modulation to further increase the number of bits that can be stored in a voxel. FIG. 9 is a high level diagram of a system 900 for generating voxels using both spatial intensity and intensity modulation and is a variation on that shown in FIG. 2 and described above. In the system 900 of FIG. 9, the light delivery system 904 comprises a first portion 906 that is configured to modulate the intensity of the input pulse (as generated by the laser 202) only, (i.e. it does not modulate the spatial intensity profile) and a second portion 907 that is configured to modulate the spatial intensity profile (e.g. as described above). The first portion 906 comprises a modulator 908 which may be an AOM or EOM. This modulator 908 is configured to modulate the intensity of the input beam only (i.e. it does not change the optical path onto which the light is output). The second portion 907 comprises a modulator 208 and one or more waveguides 210 and operates in the same way as the light delivery system 204 described above (e.g. as shown in any of FIGS. 3-7).

The light delivery system 904 receives the light output by the laser 202 and generates light with the desired intensity and spatial intensity profile which is then incident upon the substrate 206 to induce the index change in the material and form the voxel. In the example shown, the light delivery system 904 first modulates the intensity and then modulates the spatial intensity profile, although in other examples, these could be performed the other way round (e.g. the positions of the first and second portions 906, 907 may be swapped).

The high level diagram shown in FIG. 9 is a simplification of the full system, and parts not directly involved with the invention like femtosecond laser stretchers, compressors, wavelength converters, and the focusing optics to substrate are left out for clarity.

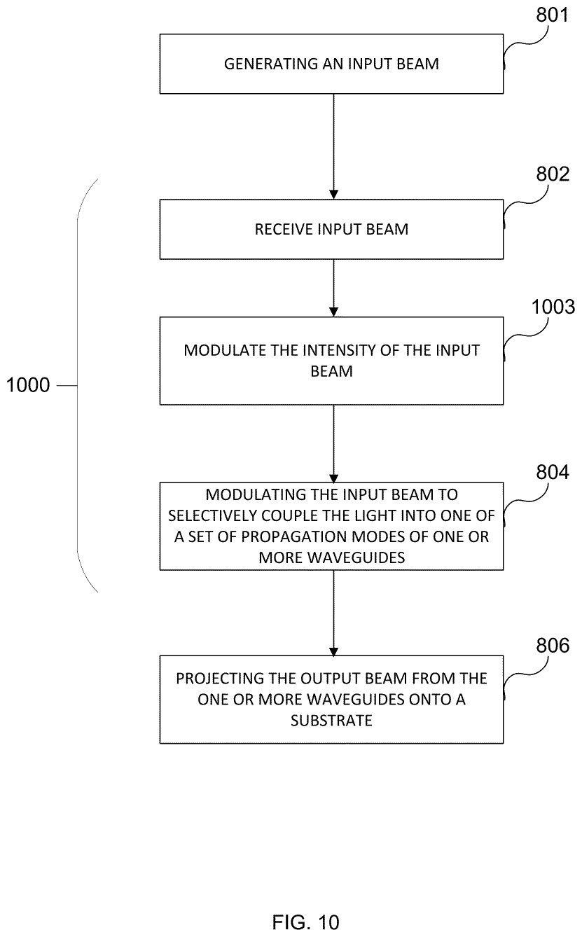

FIG. 10 shows a method 1000 of operating a light delivery system as described herein as part of a broader method of generating voxels using the apparatus of FIG. 9. The method 1000 is a variation of the method 800 shown in FIG. 8. The method 1000 of operating the light delivery system comprises receiving an input beam (block 802) and modulating the input beam to both modulate the intensity (block 1003) and to selectively couple the light into one of a set of propagation modes of one or more waveguides (block 804). As described above, the selective coupling of light into one of a set of propagation modes of one or more waveguides may involve (i) selectively coupling the input beam into one of a plurality of different propagation modes within the same waveguide (e.g. as in the examples in FIGS. 3 and 6) or (ii) selectively coupling the input beam into one of a plurality different waveguides having different propagation modes (e.g. as in the examples in FIGS. 4 and 5) before recombining the optical paths into a single output beam or (iii) selectively coupling the input beam into one of a plurality identical waveguides and then using a lens or other optical element to shape the beam output from one of the waveguides (e.g. as in the example in FIG. 7) before recombining the optical paths into a single output beam. This method 1000 forms part of the method of generating voxels which additionally comprises generating the input beam (block 801), e.g. using a femtosecond laser, and projecting the output beam from light delivery system onto a substrate (block 806).

Alternatively or in addition to the other examples described herein, examples include any combination of the following:

Clause A. A light delivery system for use in generating voxels, the light delivery system comprising: a modulator; and one or more waveguides, wherein the modulator is controllable to cause a deflection of an input light beam from a first optical path to a second optical path through the one or more waveguides, wherein the first and second optical paths have different propagation properties, resulting in a different spatial distribution of an output light beam output from the light delivery system.

Clause B. The light delivery system according to clause A, wherein the modulator is an acousto-optic modulator.

Clause C. The light delivery system according to clause A, wherein the modulator is an electro-optic modulator and wherein the light delivery system further comprises a polarization splitter.

Clause D. The light delivery system according to clause C, further comprising an optical amplifier.

Clause E. The light delivery system according to any of the preceding clauses, wherein light propagates along the first optical path in a fundamental mode and light propagates along the second optical path in a higher order mode.

Clause F. The light delivery system according to clause E, wherein the higher order mode is a first higher order mode, LP11.

Clause G. The light delivery system according to any of the preceding clauses, wherein the one or more waveguides comprises a few-moded waveguide and wherein the first optical path corresponds to a fundamental mode of the few-moded waveguide and the second optical path corresponds to a higher order mode of the few-moded waveguide.

Clause H. The light delivery system according to claim G, wherein the few-moded waveguide is a few-moded fiber.

Clause I. The light delivery system according to any of clauses A-F, wherein the one or more waveguides comprises first and second fibers, wherein the first waveguide is a single mode fiber and the second fiber comprises a single mode fiber spliced to a few-moded fiber and wherein the few-moded fiber includes a long period grating arranged to couple light from a fundamental mode of the few-moded fiber to a higher order mode of the few-moded fiber and wherein the light delivery system further comprises coupling optics arranged to combine light output from the first and second fibers to a common optical path.

Clause J. The light delivery system according to any of clauses A-F, wherein the one or more waveguides comprises first and second fibers, wherein light propagates in a fundamental mode in the first fiber and the second fiber comprises a single mode fiber spliced to a few-moded fiber with a lateral offset between cores such that light is coupled from a fundamental mode of the single mode fiber to a higher order mode of the few-moded fiber and wherein the light delivery system further comprises coupling optics arranged to combine light output from the first and second fibers to a common optical path.

Clause K. The light delivery system according to clause J, wherein the first fiber comprises a few-moded fiber and wherein the coupling optics comprises a fused-fiber coupler.

Clause L. The light delivery system according to any of clauses A-F, wherein the one or more waveguides comprises first and second fibers and wherein the light delivery system further comprises a non-circular optical element and coupling optics, wherein the non-circular optical element is positioned at an output end of the second fiber and the coupling optics is arranged to combine light output from the first and second fibers to a common optical path.

Clause M. The light delivery system according to any of clauses A-F, wherein the one or more waveguides comprises first and second waveguides, wherein the first waveguide is has a core with a circular cross-section and the second waveguide has a core with a non-circular cross-section and wherein the light delivery system further comprises coupling optics arranged to combine light output from the first and second waveguides to a common optical path.

Clause N. The light delivery system according to clause M, wherein the second waveguide has a core with an elliptical cross-section.

Clause O. The light delivery system according to any of the preceding clauses, wherein the modulator is a first modulator and the light delivery system further comprising: a second modulator configured to modulate an intensity of the input light beam prior to the input light beam being input to the first modulator.

Clause P. A method of generating voxels comprising: receiving an input beam of light at a modulator; modulating the input beam to selectively couple the input beam into a first or a second optical path, wherein the first and second optical paths have different propagation properties, resulting in a different spatial distribution of an output light beam; and projecting the output beam onto a substrate.

Clause Q. The method according to clause P, wherein the modulator is an acousto-optic modulator or an electro-optic modulator.

Clause R. The method according to clause P or Q, wherein selectively coupling the input beam into a first or a second optical path comprises: selectively coupling the input beam into one of a plurality of different propagation modes within a single waveguide.

Clause S. The method according to clause R, wherein the single waveguide is a few-moded waveguide or a multi-core waveguide.

Clause T. The method according to clause P or Q, wherein selectively coupling the input beam into a first or a second optical path comprises: selectively coupling the input beam into one of a plurality different waveguides having different propagation modes, and the method further comprises recombining the optical paths to form the output beam.

Clause U. The method according to clause P or Q, wherein selectively coupling the input beam into a first or a second optical path comprises: selectively coupling the input beam into one of a plurality identical waveguides, and the method further comprises: using a lens or other optical element to shape the beam output from one of the waveguides; and recombining the optical paths to form the output beam.

Clause V. The method according to any of clauses P-U, further comprising: modulating the intensity of the input beam prior to modulating the input beam to selectively couple the input beam into a first or a second optical path.

Clause W. Apparatus for generating voxels comprising: a laser; and a light delivery system arranged to selectively generate an output light beam having one of a plurality of pre-defined different spatial distributions.

Clause X. The apparatus according to clause W, wherein the light delivery system is the light delivery system of any of clauses A-O.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. A light delivery system for use in generating voxels, the light delivery system comprising:
a modulator; and
one or more waveguides,
wherein the modulator is controllable to cause a deflection of an input light beam from a first optical path to a second optical path through the one or more waveguides,
wherein the first and second optical paths have different propagation properties, resulting in a different spatial distribution of an output light beam output from the light delivery system.

2. The light delivery system according to claim 1, wherein the modulator is an acousto-optic modulator.

3. The light delivery system according to claim 1, wherein the modulator is an electro-optic modulator and wherein the light delivery system further comprises a polarization splitter.

4. The light delivery system according to claim 1, wherein light propagates along the first optical path in a fundamental mode and light propagates along the second optical path in a higher order mode.

5. The light delivery system according to claim 1, wherein the one or more waveguides comprises a few-moded waveguide and wherein the first optical path corresponds to a fundamental mode of the few-moded waveguide and the second optical path corresponds to a higher order mode of the few-moded waveguide.

6. The light delivery system according to claim 5, wherein the few-moded waveguide is a few-moded fiber.

7. The light delivery system according to claim 1, wherein the one or more waveguides comprises first and second fibers, wherein the first waveguide is a single mode fiber and the second fiber comprises a single mode fiber spliced to a few-moded fiber and wherein the few-moded fiber includes a long period grating arranged to couple light from a fundamental mode of the few-moded fiber to a higher order mode of the few-moded fiber and wherein the light delivery system further comprises coupling optics arranged to combine light output from the first and second fibers to a common optical path.

8. The light delivery system according to claim 1, wherein the one or more waveguides comprises first and second fibers, wherein light propagates in a fundamental mode in the first fiber and the second fiber comprises a single mode fiber spliced to a few-moded fiber with a lateral offset between cores such that light is coupled from a fundamental mode of the single mode fiber to a higher order mode of the few-moded fiber and wherein the light delivery system further comprises coupling optics arranged to combine light output from the first and second fibers to a common optical path.

9. The light delivery system according to claim 8, wherein the first fiber comprises a few-moded fiber and wherein the coupling optics comprises a fused-fiber coupler.

10. The light delivery system according to claim 1, wherein the one or more waveguides comprises first and second fibers and wherein the light delivery system further comprises a non-circular optical element and coupling optics, wherein the non-circular optical element is positioned at an output end of the second fiber and the coupling optics is arranged to combine light output from the first and second fibers to a common optical path.

11. The light delivery system according to claim 1, wherein the one or more waveguides comprises first and second waveguides, wherein the first waveguide is has a core with a circular cross-section and the second waveguide has a core with a non-circular cross-section and wherein the light delivery system further comprises coupling optics arranged to combine light output from the first and second waveguides to a common optical path.

12. The light delivery system according to claim 11, wherein the second waveguide has a core with an elliptical cross-section.

13. The light delivery system according to claim 1, wherein the modulator is a first modulator and the light delivery system further comprising:
a second modulator configured to modulate an intensity of the input light beam prior to the input light beam being input to the first modulator.

14. A method of generating voxels comprising:
receiving an input beam of light at a modulator;
modulating the input beam to selectively couple the input beam into a first or a second optical path, wherein the first and second optical paths have different propagation properties, resulting in a different spatial distribution of an output light beam; and
projecting the output beam onto a substrate.

15. The method according to claim 14, wherein the modulator is an acousto-optic modulator or an electro-optic modulator.

16. The method according to claim 14, wherein selectively coupling the input beam into a first or a second optical path comprises:
selectively coupling the input beam into one of a plurality of different propagation modes within a single waveguide.

17. The method according to claim 14, wherein selectively coupling the input beam into a first or a second optical path comprises:
selectively coupling the input beam into one of a plurality different waveguides having different propagation modes,
and the method further comprises recombining the optical paths to form the output beam.

18. The method according to claim 14, wherein selectively coupling the input beam into a first or a second optical path comprises:
selectively coupling the input beam into one of a plurality identical waveguides,
and the method further comprises:
using a lens or other optical element to shape the beam output from one of the waveguides; and
recombining the optical paths to form the output beam.

19. The method according to claim 14, further comprising:
modulating the intensity of the input beam prior to modulating the input beam to selectively couple the input beam into a first or a second optical path.

20. Apparatus for generating voxels comprising:
a laser; and
a light delivery system arranged to selectively generate an output light beam having one of a plurality of pre-defined different spatial distributions.
